(19) United States
(12) Patent Application Publication
(10) Pub. No.: US 2016/0259280 A1
(43) Pub. Date: Sep. 8, 2016

(54) FIXING DEVICE AND IMAGE FORMING APPARATUS

(71) Applicants: KABUSHIKI KAISHA TOSHIBA, Tokyo (JP); TOSHIBA TEC KABUSHIKI KAISHA, Tokyo (JP)

(72) Inventor: Sasuke Endo, Chigasaki (JP)

(21) Appl. No.: 14/637,505

(22) Filed: Mar. 4, 2015

(51) Int. Cl. G03G 15/20

(52) U.S. Cl. CPC G03G 15/2053

(57) ABSTRACT

According to one embodiment, a fixing device includes a fixing belt, a press roller, a nip pad and a friction reducing member. The fixing belt is endless. The press roller is arranged on an outer peripheral side of the fixing belt. The nip pad is arranged on an inner peripheral side of the fixing belt and faces the press roller through the fixing belt. The friction reducing member is sandwiched between the nip pad and the fixing belt. A thermal conductivity of the friction reducing member is larger than a thermal conductivity of the nip pad.

### FIELD

Embodiments described herein relate generally to a fixing device and an image forming apparatus.

### BACKGROUND

Hitherto, there is an image forming apparatus such as a multi function peripheral (hereinafter called “MFP”) and a printer. The image forming apparatus includes a fixing device. The fixing device heats a conductive layer of a fixing belt by an electromagnetic induction heating system (hereinafter called “IH system”). The fixing device fixes a toner image onto a recording medium by heat of the fixing belt. For example, the fixing device includes a press roller on an outer peripheral side of an endless fixing belt. The fixing device includes a nip pad which is located on an inner peripheral side of the fixing belt and faces the press roller through the fixing belt. The fixing device includes a friction reducing member sandwiched between the nip pad and the fixing belt in order to reduce frictional resistance between the nip pad and the fixing belt. In the fixing device, even when the friction reducing member is sandwiched between the nip pad and the fixing belt, there is a possibility that temperature unevenness occurs on the fixing belt.

### BRIEF DESCRIPTION OF THE DRAWINGS

FIG. 1 is a side view of an image forming apparatus according to an embodiment.

FIG. 2 is a side view of a fixing device including a control block of an IH coil unit according to the embodiment.

FIG. 3 is a perspective view of the IH coil unit according to the embodiment.

FIG. 4 is an explanatory view of magnetic paths to a fixing belt and a heat generation assistant member, which are formed by magnetic flux of the IH coil unit according to the embodiment.

FIG. 5 is a block diagram showing a control system to mainly control the IH coil unit according to the embodiment.

FIG. 6 is a side view of a main part of the fixing device according to the embodiment.

FIG. 7 is an explanatory view of a length of a friction reducing member in a width direction of the fixing belt according to the embodiment.

FIG. 8 is an explanatory view of an effect by the friction reducing member according to the embodiment.

### DETAILED DESCRIPTION

In general, according to one embodiment, a fixing device 34 includes a fixing belt 50, a press roller 51, a nip pad 53 and a friction reducing member 84. The fixing belt 50 is endless. The press roller 51 is arranged on an outer peripheral side of the fixing belt 50. The nip pad 53 is arranged on an inner peripheral side of the fixing belt 50 and faces the press roller 51 through the fixing belt 50. The friction reducing member 84 is sandwiched between the nip pad 53 and the fixing belt 50. A thermal conductivity α of the friction reducing member 84 is larger than a thermal conductivity 1 of the nip pad 53.

Hereinafter, an image forming apparatus 10 of an embodiment will be described with reference to the drawings. In the respective drawings, the same components are denoted by the same reference numerals.

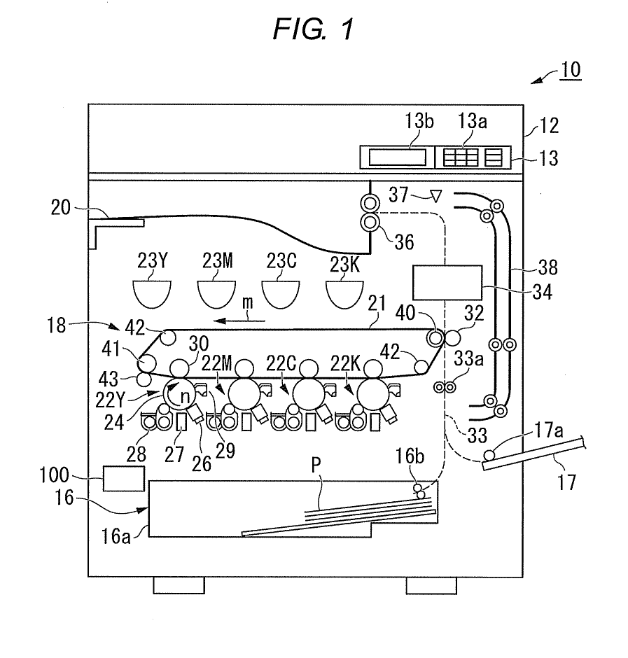

FIG. 1 is a side view of the image forming apparatus 10 of the embodiment. Hereinafter, an MFP 10 will be described as an example of the image forming apparatus 10.

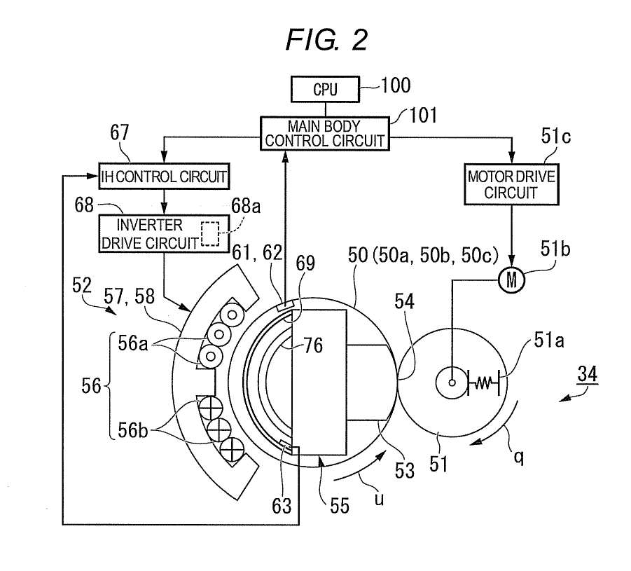

As shown in FIG. 1, the MFP 10 includes a scanner 12, a control panel 13, a paper feeding cassette part 16, a paper feeding tray 17, a printer part 18 and a paper discharge part 20. The MFP 10 includes a CPU 100 to control the whole MFP 10. The CPU 100 controls a main body control circuit 101 (see FIG. 2).

The scanner 12 reads a document image. The control panel 13 includes an input key 13a and a display part 13b. For example, the input key 13a receives an input from a user. For example, the display part 13b is of a touch panel type. The display part 13b receives an input from a user and displays to the user.

The paper feeding cassette part 16 includes a paper feeding cassette 16a and a pick-up roller 16b. The paper feeding cassette 16a contains a sheet P as a recording medium. The pick-up roller 16b extracts the sheet P from the paper feeding cassette 16a.

The paper feeding cassette 16a feeds the unused sheet P. The paper feeding tray 17 feeds the unused sheet P by a pick-up roller 17a.

The printer part 18 forms an image from the document image read by the scanner 12. The printer part 18 includes an intermediate transfer belt 21. In the printer part 18, the intermediate transfer belt 21 is supported by a backup roller 40, a driven roller 41 and a tension roller 42. The backup roller 40 includes a drive part (not shown). In the printer part 18, the intermediate transfer belt 21 is rotated in an arrow m direction.

The printer part 18 includes four sets of image forming stations 22Y, 22M, 22C and 22K. The respective image forming stations 22Y, 22M, 22C and 22K are for forming images of Y (yellow), M (magenta), C (cyan) and K (black). The image forming stations 22Y, 22M, 22C and 22K are arranged below the intermediate transfer belt 21 and in parallel along the rotation direction of the intermediate transfer belt 21.

The printer part 18 includes cartages 23Y, 23M, 23C and 23K which are arranged above the respective image forming stations 22Y, 22M, 22C and 22K. The cartages 23Y, 23M, 23C and 23K contain replenishing toners of Y (yellow), M (magenta), C (cyan) and K (black), respectively.

Hereinafter, a description will be made while using the Y (yellow) image forming station 22Y as an example among the image forming stations 22Y, 22M, 22C and 22K. Incidentally, since the image forming stations 22M, 22C and 22K have the same structure as the image forming station 22Y, a detailed description thereof is omitted.

The image forming station 22Y includes an electrifying charger 26, an exposure scanning head 27, a developing device 28 and a photoconductive cleaner 29. The electrifying charger 26, the exposure scanning head 27, the developing device 28 and the photoconductive cleaner 29 are arranged around a photoconductive drum 24 rotating in an arrow n direction.

The image forming station 22Y includes a primary transfer roller 30. The primary transfer roller 30 faces the photoconductive drum 24 through the intermediate transfer belt 21.

In the image forming station 22Y, the photoconductive drum 24 is electrified by the electrifying charger 26, and then is exposed by the exposure scanning head 27. In the image forming station 22Y, an electrostatic latent image is formed on the photoconductive drum 24. The developing device 28 uses a two-component developer made of a toner and a carrier, and develops the electrostatic latent image on the photoconductive drum 24.

The primary transfer roller 30 primarily transfers the toner image formed on the photoconductive drum 24 to the intermediate transfer belt 21. The image forming stations 22Y, 22M, 22C and 22K form color toner images on the intermediate transfer belt 21 by the primary transfer rollers 30. The color toner images are formed by sequentially overlapping the toner images of Y (yellow), M (magenta), C (cyan) and K (black). The photoconductive cleaner 29 removes toners remaining on the photoconductive drum 24 after the primary transfer.

The printer part 18 includes a secondary transfer roller 32. The secondary transfer roller 32 faces the backup roller 40 through the intermediate transfer belt 21. The secondary transfer roller 32 collectively transfers the color toner images on the intermediate transfer belt 21 to the sheet P. The sheet P is fed from the paper feeding cassette part 16 or the manual paper feeding try 17 along a conveyance path 33.

The printer part 18 includes a belt cleaner 43 facing the driven roller 41 through the intermediate transfer belt 21. The belt cleaner 43 removes toners remaining on the intermediate transfer belt 21 after the secondary transfer. Incidentally, an image forming part includes the intermediate transfer belt 21, the four sets of image forming stations (22Y, 22M, 22C and 22K), and the secondary transfer roller 32.

The printer part 18 includes a registration roller 33a, a fixing device 34 and a paper discharge roller 36 along the conveyance path 33. The printer part 18 includes a branch part 37 and a reverse conveying part 38 on a downstream side of the fixing device 34. The branch part 37 sends the sheet P after fixing to the paper discharge part 20 or the reverse conveying part 38. In the case of duplex printing, the reverse conveying part 38 reverses and conveys the sheet P, which is sent from the branch part 37, toward the registration roller 33a. The MFP 10 forms the fixed toner image on the sheet P by the printer part 18. The MFP 10 discharges the sheet P on which the fixed toner image is formed to the paper discharge part 20.

Incidentally, the MFP 10 is not limited to the tandem development system. Besides, in the MFP 10, the number of the developing devices 28 is not limited. The MFP 10 may directly transfer a toner image from the photoconductive drum 24 to the sheet P.

Hereinafter, the fixing device 34 will be described in detail.

FIG. 2 is a side view of the fixing device 34 including a control block of an electromagnetic induction heating coil unit 52 according to the embodiment. Hereinafter, the electromagnetic induction heating coil unit is called “IH coil unit”.

As shown in FIG. 2, the fixing device 34 includes a fixing belt 50, a press roller 51, the IH coil unit 52 and a heat generation assistant plate 69.

The fixing belt 50 is a tubular endless belt. A belt inner mechanism 55 including a nip pad 53 and the heat generation assistant plate 69 is arranged on an inner peripheral side of the fixing belt 50.

The fixing belt 50 is driven by the press roller 51 and rotates in an arrow u direction. Alternatively, the fixing belt 50 may rotate in the arrow u direction independently on the press roller 51. When the fixing belt 50 and the press roller 51 independently rotate, a one-way clutch may be provided so that a speed difference does not occur between the fixing belt 50 and the press roller 51.

The fixing belt 50 is formed by sequentially laminating a heat generating layer 50a as a heating part and a release layer 50c on a base layer 50b. Incidentally, the layer structure of the fixing belt 50 is not limited as long as the heat generating layer 50a is provided.

For example, the base layer 50b is made of polyimide resin (PI). For example, the heat generating layer 50a is made of non-magnetic metal such as copper (Cu). For example, the release layer 50c is made of fluorine resin such as tetrafluoroethylene-perfluoroalkyl vinyl ether copolymer (PFA).

In the fixing belt 50, in order to perform quick warming up, the heat generating layer 50a is made thin and the heat capacity is reduced. The fixing belt 50 having low heat capacity shortens the time necessary for the warming up. Energy consumption is saved by shortening the time necessary for the warming up.

For example, in the fixing belt 50, the thickness of the copper layer of the heat generating layer 50a is made 10 μm in order to reduce the heat capacity. For example, the heat generating layer, 50a is covered with a protection layer of nickel or the like. The protection layer of nickel or the like suppresses oxidation of the copper layer. The protection layer of nickel or the like improves the mechanical strength of the copper layer.

Incidentally, the heat generating layer 50a may be formed in such a manner that electroless nickel plating is applied to the base layer 50b which is made of polyimide resin, and copper plating is further applied. By applying the electroless nickel plating, adhesion strength between the base layer 50b and the heat generating layer 50a is improved. By applying the electroless nickel plating, the mechanical strength of the heat generating layer 50a is improved.

Besides, the surface of the base layer 50b may be roughened by sand blasting or chemical etching. By roughening the surface of the base layer 50b, the adhesion strength between the base layer 50b and the nickel plating of the heat generating layer 50a is further mechanically improved.

Metal such as titanium (Ti) may be dispersed in the polyimide resin constituting the base layer 50b. By dispersing the metal in the base layer 50b, the adhesion strength between the base layer 50b and the nickel plating of the heat generating layer 50a is further improved.

For example, the heat generating layer 50a may be made of nickel, iron (Fe), stainless, aluminum (Al), silver (Ag) or the like. The heat generating layer 50a may be formed by using two or more kinds of alloys, or by stacking two or more kinds of metal layers.

The heat generating layer 50a generates an eddy current by the magnetic flux generated by the IH coil unit 52. The heat generating layer 50a generates Joule heat by the eddy current and the electric resistance of the heat generating layer 50a, and heats the fixing belt 50.

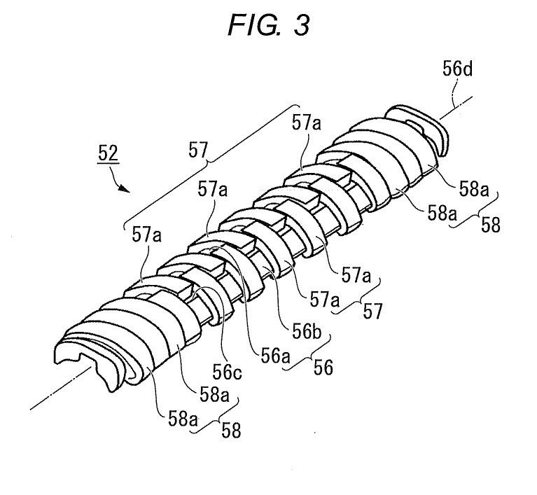

FIG. 3 is a perspective view of the IH coil unit 52 according to the embodiment.

As shown in FIG. 3, the IH coil unit 52 includes a coil 56, a first core 57 and a second core 58.

The coil 56 generates magnetic flux by application of high-frequency current. The coil 56 faces the fixing belt 50 in a thickness direction. A longitudinal direction of the coil 56 is coincident with a width direction of the fixing belt 50 (hereinafter called “belt width direction”).

The first core 57 and the second core 58 covers a side (hereinafter called “back side”) of the coil 56 opposite to the fixing belt 50. The first core 57 and the second core 58 suppress the magnetic flux generated by the coil 56 from leaking to the back side. The first core 57 and the second core 58 concentrate the magnetic flux from the coil 56 to the fixing belt 50.

The first core 57 includes plural single wing parts 57a. The plural single wing parts 57a are alternately zigzag arranged axial-symmetrically with respect to a center line 56d along the longitudinal direction of the coil 56.

The second cores 58 are arranged on both sides of the first core 57 in the longitudinal direction. The second core 58 includes plural both-wings parts 58a extending over both wings of the coil 56.

For example, the single wing part 57a and the both-wings part 58a are made of magnetic material such as nickel-zinc alloy (Ni—Zn) or manganese-nickel alloy (Mn—Ni).

The first core 57 regulates the magnetic flux generated by the coil 56 by the plural single wing parts 57a. The magnetic flux generated by the coil 56 is alternately regulated in each single wing of the coil 56 axial-symmetrically with respective to the center line 56d. The first core 57 concentrates the magnetic flux from the coil 56 to the fixing belt 50 by the plural single wing parts 57a.

The second core 58 regulates the magnetic flux generated by the coil 56 by the plural both-wings parts 58a. The magnetic flux generated by the coil 56 is regulated by both wings of the coil 56 on both sides of the first core 57. The second core 58 concentrates the magnetic flux from the coil 56 to the fixing belt 50 by the plural both-wings parts 58a. The magnetic flux concentration force of the second core 58 is higher than the magnetic flux concentration force of the first core 57.

The coil 56 includes a first wing 56a and a second wing 56b. The first wing 56a is arranged on one side with respect to the center line 56d. The second wing 56b is arranged on the other side with respect to the center line 56d. A window part 56c is formed between the first wing 56a and the second wing 56b and inside the coil 56 in the longitudinal direction.

As shown in FIG. 2, the IH coil unit 52 generates an induced current while the fixing belt 50 rotates in the arrow u direction. The heat generating layer 50a of the fixing belt 50 facing the IH coil unit 52 generates heat by the induced current.

For example, a litz wire is used for the coil 56. The litz wire is formed by bundling plural copper wires coated with heat-resistant polyamideimide as insulation material. The coil 56 is formed by winding a conductive coil.

The coil 56 generates the magnetic flux by application of high-frequency current from an inverter drive circuit 68. For example, the inverter drive circuit 68 includes an IGBT (Insulated Gate Bipolar Transistor) element 68a.

The heat generation assistant plate 69 is formed into an arc shape along the inner peripheral surface of the fixing belt 50. The heat generation assistant plate 69 faces the first wing 56a and the second wing 56b of the coil 56 through the fixing belt 50. The heat generation assistant plate 69 generates an eddy current by the magnetic flux generated by the IH coil unit 52 and generates heat. The heat generation assistant plate 69 assists the heat generation of the heat generating layer 50a of the fixing belt 50 by the IH coil unit 52. The heat generation assistant plate 69 assists heating of the fixing belt 50.

The heat generation assistant plate 69 is supported by a shield 76 from the side opposite to the coil 56. The shield 76 is formed into an arc shape similar to the heat generation assistant plate 69. The shield 76 is arranged on an inner peripheral side of the heat generation assistant plate 69. For example, the shield 76 is made of non-magnetic material such as aluminum or copper. The shield 76 shields the magnetic flux from the IH coil unit 52. The shield 76 suppresses the magnetic flux from influencing the nip pad 53 and the like.

The heat generation assistant plate 69 is made of a thin metal member made of magnetic shunt alloy, such as iron or nickel alloy, whose Curie point is 220° C. to 230° C. When the temperature is higher than the Curie point, the heat generation assistant plate 69 loses magnetic properties, and does not assist heat generation of the fixing belt 50. Since the heat generation assistant plate 69 is made of the magnetic shunt alloy, the fixing belt 50 is heated within the range of heat-resistant temperature. The heat generation assistant member and the fixing belt 50 are kept in a contact state, and a temperature difference between the heat generation assistant plate 69 and the fixing belt 50 is suppressed.

Incidentally, the heat generation assistant plate 69 may be made of a thin metal member having magnetic properties, such as iron, nickel or stainless. The heat generation assistant plate 69 may be made of resin including magnetic powder as long as the magnetic properties are provided. The heat generation assistant plate 69 may be made of following magnetic material (ferrite). The magnetic material (ferrite) promotes heat generation of the fixing belt 50 through magnetic flux generated by induced current. The magnetic material (ferrite) itself does not generate heat even if the magnetic flux generated by the induced current is applied. The heat generation assistant plate 69 is not limited to the thin plate member.

Incidentally, the heat generation assistant plate 69 may be arranged while a minute gap is provided between itself and the fixing belt 50. Alternatively, the heat generation assistant plate 69 may contact the inner peripheral surface of the fixing belt 50.

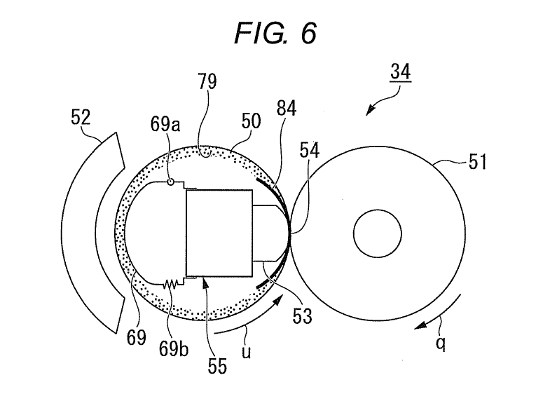

Both arc-shaped ends of the heat generation assistant plate 69 are supported by the belt inner mechanism 55. For example, the arc-shaped upper end of the heat generation assistant plate 69 is supported through a swing shaft 69a (see FIG. 6) provided along the belt width direction. The arc-shaped lower end of the heat generation assistant plate 69 is supported through an urging member 69b (see FIG. 6) such as a spring. The heat generation assistant plate 69 is urged toward the inner peripheral surface of the fixing belt 50.

Incidentally, the heat generation assistant plate 69 may be urged toward the fixing belt 50 without being swung. Besides, approaching and separating of the heat generation assistant plate 69 to and from the fixing belt 50 may be controlled. For example, the heat generation assistant plate 69 may be separated from the fixing belt 50 before warming up and may contact the fixing belt 50 after warming up.

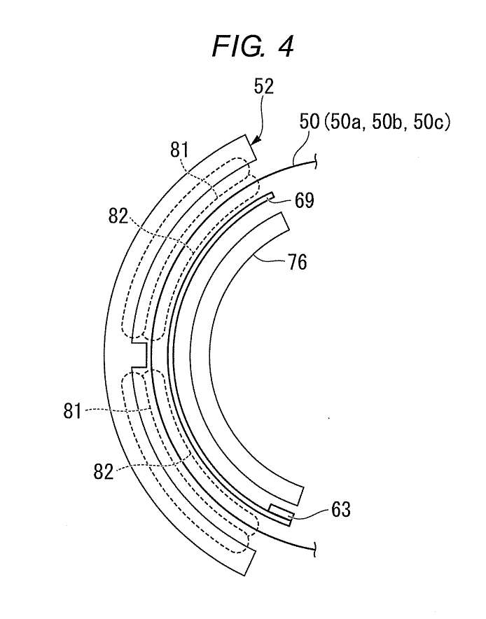

FIG. 4 is an explanatory view of magnetic paths to the fixing belt 50 and the heat generation assistant plate 69, which are formed by the magnetic flux of the IH coil unit 52 according to the embodiment. Incidentally, in FIG. 4, for convenience, illustration of the coil 56 and the like is omitted. Besides, in FIG. 4, for convenience, the fixing belt 50 and the heat generation assistant plate 69 are separated from each other.

As shown in FIG. 4, the magnetic flux generated by the IH coil unit 52 forms a first magnetic path 81 induced in the heat generating layer 50a of the fixing belt 50. The magnetic flux generated by the IH coil unit 52 forms a second magnetic path 82 induced in the heat generation assistant plate 69.

The heat generation assistant plate 69 generates heat by the magnetic flux generated by the IH coil unit 52. The heat generation assistant plate 69 assists heat generation of the heat generating layer 50a of the fixing belt 50 at warming up of the fixing belt 50 and accelerates the warming up. The heat generation assistant plate 69 assists heat generation of the heat generating layer 50a of the fixing belt 50 at printing. The fixing temperature is kept by assisting the heat generation of the heat generating layer 50a of the fixing belt 50.

As shown in FIG. 2, the nip pad 53 is a press part to press the inner peripheral surface of the fixing belt 50 to the press roller 51 side. A nip 54 is formed between the fixing belt 50 and the press roller 51.

For example, the nip pad 53 is made of elastic material such as silicone rubber or fluorine rubber. The nip pad 53 may be made of heat-resistant resin such as polyimide resin (PI), polyphenylene sulfide resin (PPS), polyethersulfone resin (PES), liquid crystal polymer (LOP) or phenol resin (PF).

FIG. 6 is a side view of a main part of the fixing device 34 according to the embodiment.

As shown in FIG. 6, a sheet-shaped friction reducing member 84 is arranged between the fixing belt 50 and the nip pad 53. For example, the friction reducing member 84 includes a sheet member excellent in sliding properties and in wear resistance and a release layer. The friction reducing member 84 is fixedly supported by the belt inner mechanism 55. The friction reducing member 84 slidably contacts the inner peripheral surface of the running fixing belt 50. The friction reducing member 84 may be made of a lubricating sheet member described below. The sheet member may be made of a glass fiber sheet impregnated with fluorine resin. The sheet member may be made of a material containing graphite or carbon fiber. When the sheet member is made of the material containing graphite or carbon fiber, the frictional resistance between the fixing belt 50 and the nip pad 53 is reduced. The friction reducing member 84 has a thin film shape, and reduces the heat capacity to improve heating properties of the fixing belt 50. Although the friction reducing member 84 is not limited to the sheet shape, thinning is preferable from the viewpoint of reducing the heat capacity. The sheet member may be made of a material containing carbon as its main ingredient. Here, the main ingredient means that the content of the ingredient is 50 weight % or more.

A thermal conductivity α of the friction reducing member 84 is larger than a thermal conductivity β of the nip pad 53. Specifically, a thermal conductivity αt of the friction reducing member 84 in the thickness direction is larger than the thermal conductivity β of the nip pad 53.

Hereinafter, the thermal conductivity of a sheet member is exemplified. The thermal conductivity of a glass fiber sheet impregnated with fluorine resin is 0.4 W/m·K in each of the surface direction and thickness direction. The thermal conductivity of a graphite sheet is 700 W/m·K in the surface direction and 26 W/m·K in the thickness direction.

Hereinafter, the thermal conductivity of a forming material of the nip pad 53 is exemplified.

The thermal conductivity of silicone rubber is 0.2 W/m·K. The thermal conductivity of fluorine rubber is 0.23 W/m·K. The thermal conductivity of polyphenylene sulfide (PPS) is 0.29 W/m·K. The thermal conductivity of liquid crystal polymer (LOP) is 0.56 W/m·K.

Hereinafter, a combination of the friction reducing member 84 and the nip pad 53 for making the thermal conductivity at of the friction reducing member 84 in the thickness direction larger than the thermal conductivity β of the nip pad 53 is exemplified.

When the glass sheet impregnated with fluorine resin is used as the friction reducing member 84, the forming material of the nip pad 53 is one of silicone rubber, fluorine rubber and polyphenylene sulfide (PPS). When the graphite sheet is used as the friction reducing member 84, the forming material of the nip pad 53 may be any of silicone rubber, fluorine rubber, polyphenylene sulfide (PPS) and liquid crystal polymer (LOP).

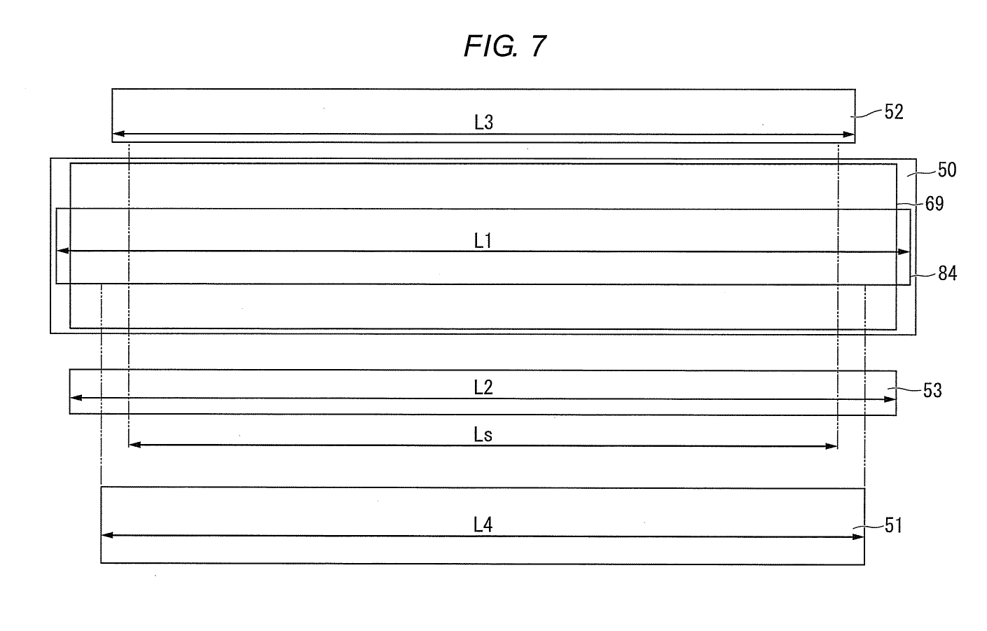

FIG. 7 is an explanatory view of a length L1 of the friction reducing member 84 in the belt width direction according to the embodiment.

Hereinafter, the length L1 of the friction reducing member 84 in the belt width direction is called “friction reducing member width”. A length L2 of the nip pad 53 in the belt width direction is called “nip pad width”. A length L3 of the IH coil unit 52 in the belt width direction is called “IH coil unit width”. A length L4 of the press roller Si in the belt width direction is called “press roller width”. A length Ls of a paper passing area (sheet P) in the belt width direction is called “sheet width”.

The sheet width Ls is a width of a sheet having the largest short side width among sheets to be used. For example, the sheet width Ls is equal to the short side width of an A3 sheet.

As shown in FIG. 7, the friction reducing member width L1 is larger than the nip pad width L2. Incidentally, the friction reducing member width L1 may be equal to the nip pad width L2.

The friction reducing member width L1 is larger than the IH coil unit width L3. Incidentally, the friction reducing member width L1 may be equal to the IH coil unit width L3.

The friction reducing member width L1 is larger than the press roller width L4.

The friction reducing member width L1 is larger than the sheet width Ls.

The friction reducing member width L1, the nip pad width L2, the IH coil unit width L3, the press roller width L4 and the sheet width Ls have the relation of the following expression (1).

L1≧L2≧L3≧L4≧Ls expression (1)

As shown in FIG. 2, for example, the press roller 51 includes a heat-resistant silicone sponge, silicone rubber layer or the like around a core metal. For example, a release layer is arranged on the surface of the press roller 51. The release layer is made of fluorine resin such as PFA resin. The press roller Si pressurizes the fixing belt 50 by a pressurizing mechanism. The press roller 51, together with the nip pad 53, is a pressurizing part for pressurizing the fixing belt 50. The press roller Si rotates in an arrow q direction by a motor 51b. The motor 51b is driven by a motor drive circuit 51c controlled by the main body control circuit 101.

A center thermistor 61 and an edge thermistor 62 detect temperature of the fixing belt 50, and input the temperature to the main body control circuit 101. The center thermistor 61 is arranged at the inside in the belt width direction. The edge thermistor 62 is arranged outside the IH coil unit 52 in the belt width direction. The edge thermistor 62 is not influenced by the IH coil unit 52 and detects the outside temperature of the fixing belt 50 in the belt width direction at high accuracy.

The main body control circuit 101 controls an IH control circuit 67 according to the detection result of the center thermistor 61 and the edge thermistor 62. The IH control circuit 67 is controlled by the main body control circuit 101 and controls high-frequency current outputted by the inverter drive circuit 68. The fixing belt 50 keeps various control temperature ranges according to the output of the invertor drive circuit 68.

A thermostat 63 functions as a safety device for the fixing device 34. The thermostat 63 operates when the fixing belt 50 abnormally generates heat and the temperature rises to a shutting off threshold value. The current to the IH coil unit 52 is shut off by the operation of the thermostat 63. When the current to the IH coil unit 52 is shut off, the MFP 10 stops driving and suppress the abnormal heat generation of the fixing device 34.

A lubricating oil 79 is applied to the inner peripheral surface of the fixing belt 50. The lubricating oil 79 is an oil made of silicon or fluorine. The lubricating oil 79 is a lubricant for lubricating the inner peripheral surface of the fixing belt 50. The lubricating oil 79 reduces frictional resistance between the friction reducing member 84 and the inner peripheral surface of the fixing belt 50. The lubricating oil 79 may be impregnated in the fixing belt 50. Incidentally, when the heat generation assistant plate 69 and the inner peripheral surface of the fixing belt 50 contact each other, the lubricating oil 70 reduces frictional resistance between the heat generation assistant plate 69 and the inner peripheral surface of the fixing belt 50.

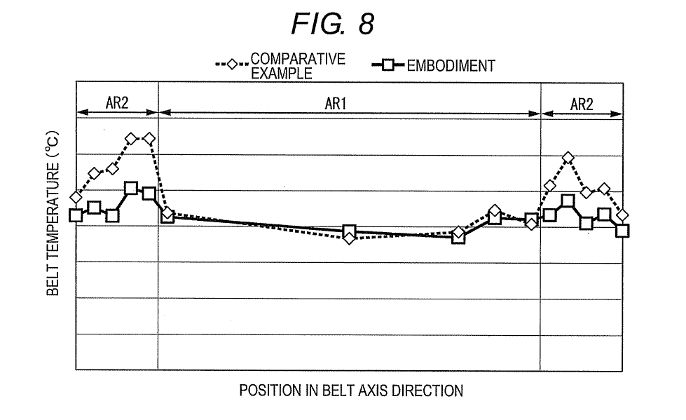

FIG. 8 is an explanatory view of effects obtained by the friction reducing member 84 according to the embodiment. Hereinafter, temperature of the fixing belt 50 is called “belt temperature”.

In FIG. 8, the horizontal axis indicates position in the belt width direction, and the vertical axis indicates belt temperature (° C.). Reference character AR1 denotes a paper passing area having a specified width at the center in the belt width direction. Reference character AR2 denotes a non-paper passing area having a specified with at both end parts in the belt width direction. In the embodiment, the thermal conductivity αt of the friction reducing member 84 in the thickness direction is larger than the thermal conductivity β of the nip pad 53. In a comparative example, the thermal conductivity αt of the friction reducing member 84 in the thickness direction is smaller than the thermal conductivity β of the nip pad 53.

As shown in FIG. 8, in the comparative example, although temperature unevenness of the belt temperature in the paper passing area AR1 is small, temperature unevenness of the belt temperature in the non-paper passing area AR2 is large. In the comparative example, temperature change of the belt temperature is remarkable particularly in the boundary portion between the paper passing area AR1 and the non-paper passing area AR2.

On the other hand, in the embodiment, temperature unevenness of the belt temperature in the paper passing area AR1 is small similarly to the comparative example, and temperature unevenness of the belt temperature in the non-paper passing area A2 is smaller than that of the comparative example. In the embodiment, temperature change of the belt temperature is small in the boundary portion between the paper passing area AR1 and the non-paper passing area AR2 as compared with the comparative example.

Hereinafter, a control system 110 of the IH coil unit 52 for heating the fixing belt 50 will be described in detail.

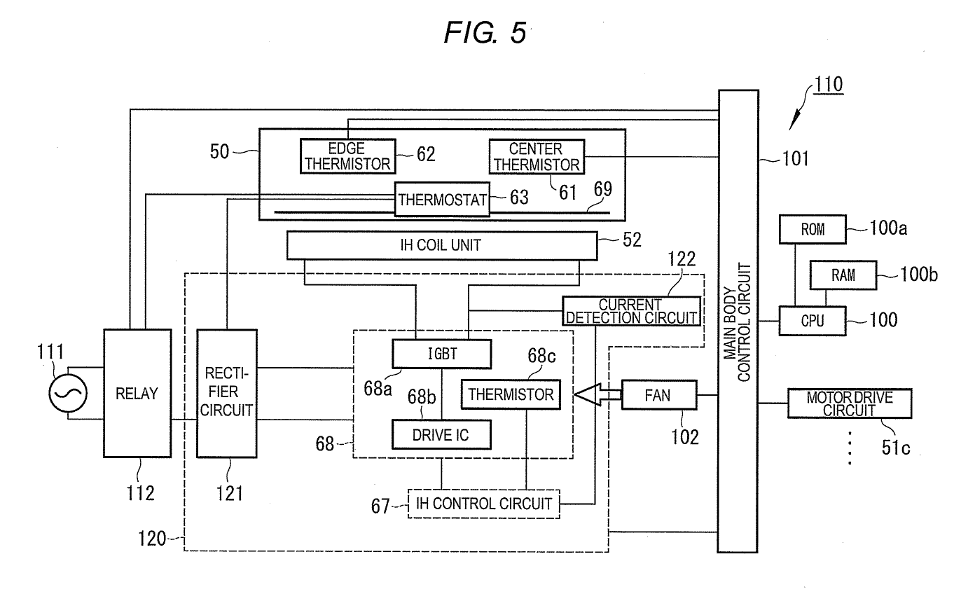

FIG. 5 is a block diagram showing the control system 110 for mainly controlling the IH coil unit 52 according to the embodiment.

As shown in FIG. 5, the control system 110 includes the CPU 100, a read only memory (ROM) 100a, a random access memory (RAM) 100b, the main body control circuit 101, an IH circuit 120, and the motor drive circuit 51c.

The control system 110 supplies power to the IH coil unit 52 by the IH circuit 120. The IH circuit 120 includes a rectifier circuit 121, an IH control circuit 67, an inverter drive circuit 68 and a current detection circuit 122.

Current is inputted to the IH circuit 120 from an AC power source 111 through a relay 112. The IH circuit 120 rectifies the inputted current by the rectifier circuit 121 and supplies the current to the inverter drive circuit 68. When the thermostat 63 is cut off, the relay 112 shuts off the current from the AC power source 111. The inverter drive circuit 68 includes a drive IC 68b of an IGBT element 68a and a thermistor 68c. The thermistor 68c detects the temperature of the IGBT element 68a. When the thermistor 68c detects the temperature rise of the IGBT element 68a, the main body control circuit 101 drives a fan 102 and cools the IGBT element 68a. The IH control circuit 67 controls the drive IC 68b according to the detection results of the center thermistor 61 and the edge thermistor 62. The IH control circuit 67 controls the drive IC 68b and controls the output of the IGBT element 68a. The current detection circuit 122 sends the detection result of the output of the IGBT element 68a to the IH control circuit 67. The IH control circuit 67 uses the detection result of the current detection circuit 122 and controls the drive IC 68b so that the supply power to the coil 56 becomes constant.

Hereinafter, the operation of the fixing device 34 at warming up will be described.

As shown in FIG. 2, at warming up, in the fixing device 34, the press roller 51 is rotated in the arrow q direction, and the fixing belt 50 is driven to rotate in the arrow u direction. The IH coil unit 52 generates magnetic flux on the fixing belt 50 side by application of high-frequency current by the inverter drive circuit 68.

As shown in FIG. 4, the magnetic flux of the IH coil unit 52 is guided to the first magnetic path 81 passing through the heat generating layer 50a of the fixing belt 50 and heats the heat generating layer 50a. The magnetic flux of the IH coil unit 52 passing through the fixing belt 50 is guided to the second magnetic path 82 passing through the heat generation assistant plate 69 and heats the heat generation assistant plate 69.

The heat generated by the heat generation assistant plate 69 is conducted to the fixing belt 50. The heat conduction from the heat generation assistant plate 69 to the fixing belt 50 promotes quick warming up of the fixing belt 50.

As shown in FIG. 2, the IH control circuit 67 controls the inverter drive circuit 68 according to the detection result of the center thermistor 61 or the edge thermistor 62. The inverter drive circuit 68 supplies high-frequency current to the coil 56.

Hereinafter, the operation of the fixing device 34 at the time of fixing operation will be described.

After the fixing belt 50 reaches the fixing temperature and the warming up is ended, when a print request occurs, the MFP 10 (see FIG. 1) starts a print operation. The MFP 10 forms a toner image on the sheet P by the printer part 18, and conveys the sheet P to the fixing device 34.

The MFP 10 sends the sheet P on which the toner image is formed to the nip 54 between the fixing belt 50 the temperature of which reaches the fixing temperature and the press roller 51. The fixing device 34 fixes the toner image to the sheet P. While the fixing is performed, the IH control circuit 67 controls the IH coil unit 52 and keeps the fixing belt 50 at the fixing temperature.

The heat of the fixing belt 50 is absorbed by the sheet P in the fixing operation. For example, when paper passing is continuously performed at high speed, the amount of heat absorbed by the sheets P is large, and accordingly, the fixing belt 50 having low heat capacity may not keep the fixing temperature. The heat conduction from the heat generation assistant plate 69 to the fixing belt 50 heats the fixing belt 50 from the inner peripheral side of the fixing belt 50 and compensates the insufficiency of the amount of belt heat generation. The heating of the fixing belt 50 by the heat generation assistant plate 69 keeps the temperature of the fixing belt 50 at the fixing temperature even at the high-speed continuous paper passing.

In the fixing device 34, even when the friction reducing member 84 is sandwiched between the nip pad 53 and the fixing belt 50, there is a possibility that temperature unevenness occurs on the fixing belt 50. However, the thermal conductivity α of the friction reducing member 84 is larger than the thermal conductivity β of the nip pad 53. Since the thermal conductivity α of the friction reducing member 84 is larger than the thermal conductivity β of the nip pad 53, the temperature unevenness of the fixing belt 50 is suppressed.

According to the embodiment, the thermal conductivity α of the friction reducing member 84 is larger than the thermal conductivity β of the nip pad 53. Since the thermal conductivity α of the friction reducing member 84 is larger than the thermal conductivity β of the nip pad 53, as compared with the case where the thermal conductivity α of the friction reducing member 84 is smaller than the thermal conductivity β of the nip pad 53, the heat of the fixing belt 50 is liable to conduct also in the belt width direction of the friction reducing member 84. Since the heat of the fixing belt 50 conducts in the belt width direction by the friction reducing member 84, the belt temperature is uniformed in the belt width direction. Since the belt temperature is uniformed in the belt width direction, the temperature unevenness of the fixing belt 50 can be suppressed.

In general, when the thermal conductivity of the friction reducing member 84 in the belt width direction is increased, the thermal conductivity of the friction reducing member 84 in the thickness direction also increases. When the thermal conductivity of the friction reducing member 84 in the thickness direction increases, the heat is liable to conduct to the nip pad 53. When the heat conducts to the nip pad 53, the heat generation amount of the fixing belt 50 increases. When the thermal conductivity of the friction reducing member 84 in the thickness direction increases, the friction reducing member 84 may reduce the heating efficiency of the fixing device 34.

On the other hand, according to the embodiment, the thermal conductivity αt of the friction reducing member 84 in the thickness direction is larger than the thermal conductivity β of the nip pad 53. Since the thermal conductivity αt of the friction reducing member 84 in the thickness direction is larger than the thermal conductivity β of the nip pad 53, as compared with the case where the thermal conductivity αt of the friction reducing member 84 in the thickness direction is smaller than the thermal conductivity β of the nip pad 53, heat is hard to conduct to the nip pad 53. Since the heat is hard to conduct to the nip pad 53, increase of the heat generation amount of the fixing belt 50 is suppressed. Since the increase of the heat generation amount of the fixing belt 50 is suppressed, the heating efficiency of the fixing device 34 can be improved.

A glass fiber sheet impregnated with fluorine resin is used for the friction reducing member 84. When the glass fiber sheet impregnated with fluorine resin is used for the friction reducing member 84, the forming material of the nip pad 53 is one of silicone rubber, fluorine rubber and polyphenylene sulfide (PPS). When the glass fiber sheet impregnated with fluorine resin is used for the friction reducing member 84, the thermal conductivity αt of the friction reducing member 84 in the thickness direction can be made larger than the thermal conductivity β of the nip pad 53. When the glass fiber sheet impregnated with fluorine resin is used for the friction reducing member 84, the increase of the heat generation amount of the fixing belt 50 is suppressed, and the heat efficiency of the fixing device 34 can be improved.

A graphite sheet may be used for the friction reducing member 84. When the graphite sheet is used for the friction reducing member 84, any of silicone rubber, fluorine rubber, polyphenylene sulfide (PPS) and liquid crystal polymer (LOP) may be used as the forming material of the nip pad 53. When the graphite sheet is used for the friction reducing member 84, the thermal conductivity αt of the friction reducing member 84 in the thickness direction can be made larger than the thermal conductivity β of the nip pad 53. When the graphite sheet is used for the friction reducing member 84, the increase of the heat generation amount of the fixing belt 50 is suppressed, and the heating efficiency of the fixing device 34 can be improved.

The nip pad 53 is made of elastic material. When the nip pad 53 is made of the elastic material, adhesion between the nip pad 53 and the friction reducing member 84 can be enhanced.

The nip pad 53 is made of heat-resistant resin. When the nip pad 53 is made of the heat-resistant resin, influence of heat conducted from the friction reducing member 84 to the nip pad 53 can be reduced.

The friction reducing member width L1 is equal to the nip pad width L2 or is larger than the nip pad width L2 (L1≧L2). When L1≧L2 is established, as compared with the case of L1<L2, the belt temperature is efficiently uniformed in the belt width direction.

The friction reducing member width L1 is equal to the IH coil unit width L3 or is larger than the IH coil unit width L3 (L1≧L3). When L1≧L3 is established, as compared with the case of L1<L3, increase of heat generation amount of the fixing belt 50 is efficiently suppressed in the belt width direction.

The lubricating oil 79 is supplied between the sheet-shaped friction reducing member 84 and the fixing belt 50. The frictional resistance between the inner peripheral surface of the fixing belt 50 and the friction reducing member 84 is reduced by the lubricating oil 79. Accordingly, increase of driving load of the fixing device 34 is suppressed and the fixing operation can be made high in speed.

According to at least one embodiment described above, the thermal conductivity α of the friction reducing member 84 is larger than the thermal conductivity β of the nip pad 53. Since the thermal conductivity α of the friction reducing member 84 is larger than the thermal conductivity β of the nip pad 53, as compared with the case where the thermal conductivity α of the friction reducing member 84 is smaller than the thermal conductivity β of the nip pad 53, the heat of the fixing belt 50 is liable to conduct also in the belt width direction of the friction reducing member 84. Since the heat of the fixing belt 50 is conducted in the belt width direction by the friction reducing member 84, the belt temperature is uniformed in the belt width direction. Since the belt temperature is uniformed in the belt width direction, the temperature unevenness of the fixing belt 50 can be suppressed.

While certain embodiments have been described these embodiments have been presented by way of example only, and are not intended to limit the scope of the inventions. Indeed, the novel embodiments described herein may be embodied in a variety of other forms: furthermore various omissions, substitutions and changes in the form of the embodiments described herein may be made without departing from the spirit of the inventions. The accompanying claims and there equivalents are intended to cover such forms or modifications as would fall within the scope and spirit of the invention.

1. A fixing device comprising:
an endless fixing belt;
a press roller arranged on an outer peripheral side of the fixing belt;
a nip pad which is arranged on an inner peripheral side of the fixing belt and faces the press roller through the fixing belt; and
a friction reducing member sandwiched between the nip pad and the fixing belt, wherein
a thermal conductivity of the friction reducing member is larger than a thermal conductivity of the nip pad,
a length L1 of the friction reducing member in a width direction of the fixing belt is equal to a length L2 of the nip pad in the width direction of the fixing belt or is larger than the length L2 of the nip pad in the width direction of the fixing belt,
the fixing belt includes a conductive layer,
an induced current generation part is arranged on the outer peripheral side of the fixing belt and at a position avoiding the press roller, and heats the conductive layer by electromagnetic induction,
the length L1 of the friction reducing member in the width direction of the fixing belt is equal to a length L3 of the induced current generation part in the width direction of the fixing belt or is larger than the length L3 of the induced current generation part in the width direction of the fixing belt, and
the length L1 of the friction reducing member in the width direction of the fixing belt is less than a width of the fixing belt.

2. The device according to claim 1, wherein
the friction reducing member is a sheet member supported on a side of the nip pad, and
the thermal conductivity of the friction reducing member in a thickness direction is larger than the thermal conductivity of the nip pad.

3. The device according to claim 1, wherein
the friction reducing member includes a sheet member made of a glass fiber sheet impregnated with fluorine resin.

4. The device according to claim 1, wherein
the friction reducing member includes a sheet member made of a material containing one of graphite and carbon fiber.

5. The device according to claim 1, wherein
the nip pad is made of an elastic material.

6. The device according to claim 1, wherein
the nip pad is made of a heat-resistant resin.

7-8. (canceled)

9. The device according to claim 1, wherein
the friction reducing member is a sheet member supported on a side of the nip pad, and
a lubricant is supplied between the friction reducing member and the fixing belt.

10. An image forming apparatus comprising:
an image forming part to form an image on a recording medium; and
a fixing device according to claim 1 for fixing the image to the recording medium.
